(19) United States
(12) Patent Application Publication
(10) Pub. No.: US 2022/0101445 A1
(43) Pub. Date: Mar. 31, 2022

(54) NEXT GENERATION IMAGING SYSTEM ANALYTICAL MANAGEMENT METHOD AND DEVICE

(71) Applicant: STATE FARM MUTUAL AUTOMOBILE INSURANCE COMPANY, Bloomington, IL (US)

(72) Inventors: PAUL D. MITCHELL, Danvers, IL (US); JEFFERY D. NOAK, Towanda, IL (US); CHARLES SHIPMAN, San Tan Valley, AZ (US); GRANT VINCENT EDWARDS, Mapleton, IL (US)

(73) Assignee: STATE FARM MUTUAL AUTOMOBILE INSURANCE COMPANY, BLOOMINGTON, IL (US)

(21) Appl. No.: 17/494,088

(22) Filed: Oct. 5, 2021

Related U.S. Application Data
(63) Continuation of application No. 15/397,192, filed on Jan. 3, 2017.
(60) Provisional application No. 62/275,465, filed on Jan. 6, 2016.
(60) Provisional application No. 62/313,859, filed on Mar. 28, 2016.
(60) Provisional application No. 62/326,912, filed on Apr. 25, 2016.

(51) Int. Cl. G06Q 40/08; G06K 9/00; G06F 9/48

(52) U.S. Cl. CPC G06Q 40/08; G06F 9/4843; G06K 9/0063

(57) ABSTRACT

An analytical framework facilitates various applications analyzing files stored in a database. In one aspect, a computer-implemented method for managing the analysis of image, video, audio, and document files stored in a repository includes (1) receiving a request to add an analysis application to a registry of applications; (2) receiving a specification of types of files from the repository to be analyzed by the analysis application; (3) receiving a schedule of times at which the analysis application is to be executed or an indication of near real-time execution; (4) executing the analysis application on the specified types of files at the scheduled time; (5) receiving an indication that the specified types of files have been added to the repository; and (6) executing the analysis application on the specified types of files if near real-time execution is indicated. The analysis applications may relate to auto, home, life, and personal articles insurance.

### RELATED APPLICATIONS

The current non-provisional patent application is a continuation of and claims priority benefit to U.S. patent application Ser. No. 15/397,192, titled “NEXT GENERATION IMAGING SYSTEM ANALYTICAL METHOD AND DEVICE,” filed Jan. 3, 2017, which claims priority benefit to U.S. Provisional Application Ser. No. 62/326,912, titled “NEXT GENERATION IMAGING SYSTEM ANALYTICAL MANAGEMENT METHOD AND DEVICE”, filed Apr. 25, 2016, U.S. Provisional Application Ser. No. 62/313,859, titled “NEXT GENERATION IMAGING SYSTEM ANALYTICAL MANAGEMENT METHOD AND DEVICE”, filed Mar. 28, 2016, and U.S. Provisional Application Ser. No. 62/275,465, titled “NEXT GENERATION IMAGING SYSTEM ANALYTICAL MANAGEMENT METHOD AND DEVICE”, filed Jan. 6, 2016. The earlier-filed applications listed above are hereby incorporated by reference, in their entirety and for all purposes, herein.

### FIELD OF THE INVENTION

The present disclosure generally relates to methods and devices for managing the analysis of images stored in a next generation imaging system.

### BACKGROUND

Corporations, such as insurance providers, may accumulate a large number of image files, including photographs and scanned documents, through normal business practices. For example, numerous photographs of an insured's property, such as a vehicle or a house, may be taken for each claim of loss that is filed. In some instances, video, captured from a drone or a handheld video camera or smartphone, and/or audio, captured from a standalone microphone or a smartphone, may also be submitted as part of a claim. In addition, documents, such as insurance policies, medical records, certificates, legal documents, and the like, may be scanned so that they can be accessed on electronic devices. Typically, the image, video, audio, and document files are stored in a repository or database. However, if the corporation is large, then there may be multiple repositories that are geographically separated. Also, there may be multiple types of repositories, such as one repository for each type of file.

To process claims and maintain up-to-date records, various groups within the corporation may wish to extract data from the files. For example, a first group may wish to access images or video and audio of a vehicle that has been in a vehicle collision to view the damage done. A second group may wish to access images or video and audio of a house that has been damaged. Other groups may wish to access images of documents to extract text contained in the documents. Each group may utilize one or more software applications which analyze the images to extract data. Currently, there is no system that allows each group to run their software on the target files. Additionally, some groups may have partial, or even no, access to the files, or may not even know where the images are stored. Furthermore, since files are added to repositories every day, groups may not be aware that there are new files which may need to be analyzed.

### BRIEF SUMMARY

Embodiments of the present technology may relate to computer-implemented methods, computing devices, and computer-readable media for managing the analysis of image, video, audio, and document files stored in a repository. The embodiments may provide for establishing a registry that stores information about analysis applications which analyze files in the repository. The information may include a specification of the types of files to be analyzed, a schedule of when analysis is to be performed, and the like for each analysis application. Based upon this information, the embodiments execute each analysis application on the appropriate files at the appropriate times.

In a first aspect, a computer-implemented method for managing the analysis of image, video, audio, and document files stored in a repository may be provided. The method may include: (1) receiving a request to add an analysis application to a registry of applications; (2) receiving a specification of one or more types of files from the repository to be analyzed by the analysis application; (3) receiving a schedule of times at which the analysis application is to be executed or an indication of near real-time execution; (4) executing the analysis application on the specified types of files at the scheduled time if the schedule of times is received; (5) receiving a first indication that the specified types of files have been added to the repository; and/or (6) executing the analysis application on the specified types of files if near real-time execution is indicated. The method may include additional, fewer, or alternative actions, including those discussed elsewhere herein.

In another aspect, a computer-readable medium for managing the analysis of image, video, audio, and document files stored in a repository may be provided. The computer-readable medium may include an executable program stored thereon, wherein the program instructs a processing element of a computing device to perform the following: (1) receiving a request to add an analysis application to a registry of applications; (2) receiving a specification of one or more types of files from the repository to be analyzed by the analysis application; (3) receiving a schedule of times at which the analysis application is to be executed or an indication of near real-time execution; (4) executing the analysis application on the specified types of files at the scheduled time if the schedule of times is received; (5) receiving a first indication that the specified types of files have been added to the repository; and/or (6) executing the analysis application on the specified types of files if near real-time execution is indicated. The program stored on the computer-readable medium may instruct the processing element to perform additional, fewer, or alternative actions, including those discussed elsewhere herein.

In yet another aspect, a computing device for managing the analysis of image, video, audio, and document files stored in a repository may be provided. The computing device may include a communication element, a memory element, and a processing element. The communication element may communicate with the repository. The memory element may be electronically coupled to the communication element and may store executable instructions. The processing element may be electronically coupled to the communication element and the memory element. The processing element may be configured to (1) receive a request to add an analysis application to a registry of applications; (2) receive a specification of one or more types of files from the repository to be analyzed by the analysis application; (3) receive a schedule of times at which the analysis application is to be executed or an indication of near real-time execution; (4) execute the analysis application on the specified types of files at the scheduled time if the schedule of times is received; (5) receive a first indication that the specified types of files have been added to the repository; and/or (6) execute the analysis application on the specified types of files if near real-time execution is indicated. The computing device may include additional, fewer, or alternate components and/or functionality, including that discussed elsewhere herein.

Advantages of these and other embodiments will become more apparent to those skilled in the art from the following description of the exemplary embodiments which have been shown and described by way of illustration. As will be realized, the present embodiments described herein may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of methods and devices disclosed therein. It should be understood that each Figure depicts an embodiment of a particular aspect of the disclosed methods and devices, and that each of the Figures is intended to accord with a possible embodiment thereof. Further, wherever possible, the following description refers to the reference numerals included in the following Figures, in which features depicted in multiple Figures are designated with consistent reference numerals. The present embodiments are not limited to the precise arrangements and instrumentalities shown in the Figures.

FIG. 1 illustrates an exemplary environment in which various embodiments of a computing device, configured to manage the analysis of image, video, audio, and document files stored in a repository, may operate, the environment including the repository and a plurality of electronic devices, which may transmit files through a communication network to the repository;

FIGS. 2A and 2B illustrate at least a portion of an exemplary computer-implemented method for managing the analysis of image, video, audio, and document files stored in a repository; and

FIG. 3 illustrates an exemplary environment in which various embodiments of a system, configured to manage the analysis of image, video, audio, and document files stored in a repository, may operate, the environment including an analysis application development server, an operational server, and a processing server.

The Figures depict exemplary embodiments for purposes of illustration only. One skilled in the art will readily recognize from the following discussion that alternative embodiments of the systems and methods illustrated herein may be employed without departing from the principles of the invention described herein.

### DETAILED DESCRIPTION

The present embodiments described in this patent application and other possible embodiments address a computer-centric challenge or problem with a solution that is necessarily rooted in computer technology and may relate to, inter alia, methods and devices for managing the analysis of image, video, audio, and document files stored in a repository. The files may be accumulated by a corporation, such as an insurance or financial services provider, through normal business practices. The file repository may be stored in a Hadoop database, as an example, and may reside in a computer server. The image files may include photographic images, taken with a standalone camera or a smartphone. The photographic images may include photographs of an insured's property, such as a vehicle, a house, or a personal article, in either damaged or undamaged condition. In some instances, the images may also include photographs of individuals. The photographic image files may be stored in known image data formats, such as jpeg, gif, tiff, and the like.

The video files may include video (moving image) data captured with a handheld video/picture camera, a camcorder, a smartphone, or the like. The video files may also be captured by a drone. In addition, the video files may include integrated audio or sound. The video of the video files may show undamaged or damaged houses, vehicles, motorcycles, boats, or other property. The video may also show individuals providing statements or other information relating to insurance, underwriting, or financial services. The video files may be stored in known video data formats, such as mp4, wmv, mov, avi, fly, and so forth.

The audio files may include sound captured with a standalone microphone or electronic devices such as smartphones, personal data assistants (PDAs), or the like. The audio of the audio files may include individuals providing statements, agents providing audio description, or sounds relevant to a claim. The audio files may be stored in known audio data formats, such as mp3, way, flac, wma, and so forth.

The scanned document files may include scans or images of documents such as insurance policies, medical records, certificates, legal documents, appraisals, estimates, titles, deeds, receipts, loan documentation, driver licenses, identification cards, financial accounts, and so forth. The scanned document files may be stored in formats such as pdf or one of the photographic image formats.

Various groups within the insurance provider organization may wish to access one or more of the files in order to analyze the data contained therein. For example, images or videos of the insured's property without damage may be analyzed to determine an amount of a home or auto insurance policy premium. Similarly, images, videos, or audio of insured individuals may provide identification or may be analyzed to determine an amount of a life insurance policy premium. Images or video of the insured's property that show damage, perhaps from an auto accident or a house fire, may be analyzed to determine the amount of reimbursement for a claim that was filed. The images or video may also be analyzed to determine an appropriate repair shop or a list of replacement parts for a damaged vehicle or a contractor to rebuild a damaged house. In other situations, images of documents may be analyzed to extract text or data contained in the documents. Each group may utilize one or more analysis software applications which perform analysis on the appropriate files.

Instead of each group of people (such as working or organizational groups (or departments) associated with auto insurance, life insurance, personal articles insurance, home or renters insurance, various types of insurance applications, various types of insurance claims, home or other loans, and/or vehicle loans) attempting to locate the relevant files and execute the analysis applications as they are able to, embodiments of the current technology provide a computing device and methods which manage all of the aspects of the analysis process. The computing device may receive a request from a group to add an analysis application to a registry of applications. In response, the computing device may gather some information from the group as follows regarding the operation of the analysis application. The computing device may query the group to indicate which type of files should be analyzed.

As an example, the group may indicate that they are interested in damaged automobile photos. The computing device may query the group to indicate whether they want to execute the analysis application on a near real-time basis (which is nearly as soon as the files are stored in the repository) or whether the files should be analyzed at regularly scheduled intervals. The group may indicate near real-time analysis or may provide a schedule, such as once a day, twice a day, or the like. The computing device may further query the group as to whether to analyze newly-added files only, or whether to also analyze previously-added files. The analysis application may include neural network software or other computer learning software and thus, the group may be interested in analyzing previously-added files.

If the group indicated that they want to analyze previously-added files, then the computing device may determine which files in the repository match the type of file to be analyzed. Typically, the files in the repository may include metadata or tags that indicate what the content of the file might be. For example, images of damaged vehicles may include tags such as “Auto damage front view” along with a creation date of the photo, a vehicle identification number (VIN) of the auto, or the like, videos of damaged houses may include tags that identify the address of the house and the type of damage, audio of an individual may include tags that identify the person and a descriptive title of the audio content, and document files may include tags that identify the content of the document.

Thus, in the current example, the computing device may create a list of, or otherwise identify, all of the files that match the target type of file. Then, the computing device may execute the analysis application on the identified files. The computing device may create an analysis results file, which includes the analyzed data, for each of the files that were analyzed. The computing device may also create a log of which files were analyzed and send a message to the group indicating that the analysis has been completed.

The computing device may receive an indication from the repository when files of the specified type have been added to the repository. Alternatively, the computing device may check at regular intervals in the repository for newly-added files. If the group indicated that files should be analyzed on a near real-time basis, then the computing device may execute the analysis application on the newly-added files. The computing device may create an analysis results file for each of the files that were analyzed. The computing device may also create a log of which files were analyzed and send a message to the group indicating that the analysis has been completed.

If the group indicated that the files should be analyzed at regularly scheduled intervals, then the computing device may wait until the next scheduled time at which analysis should be performed. Once the time occurs, the computing device may execute the analysis application. On the first occasion of executing the analysis application, the computing device may analyze all of the previously-added files of the specified type. Or, the computing device may analyze only the specified type of files that have been added in the last time interval. The computing device may create an analysis results file for each of the files that were analyzed. The computing device may also create a log of which files were analyzed and send a message to the group indicating that the analysis has been completed.

Periodically, the group may provide an upgrade or a new version of the analysis application. The computing device may query the group to indicate whether to analyze previously-analyzed files. The computing device may also query the group to indicate whether to overwrite the analysis results files from previous analyses, if the group indicated to reanalyze previously-analyzed files. The computing device may execute the analysis application on the previously-analyzed files, if that was indicated. Furthermore, the computing device may overwrite the analysis results files from previous analyses, if that was indicated as well. The computing device may also create a log of which files were analyzed and send a message to the group indicating that the analysis has been completed.

Specific embodiments of the technology will now be described in connection with the attached drawing figures. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

### Exemplary Computing Device

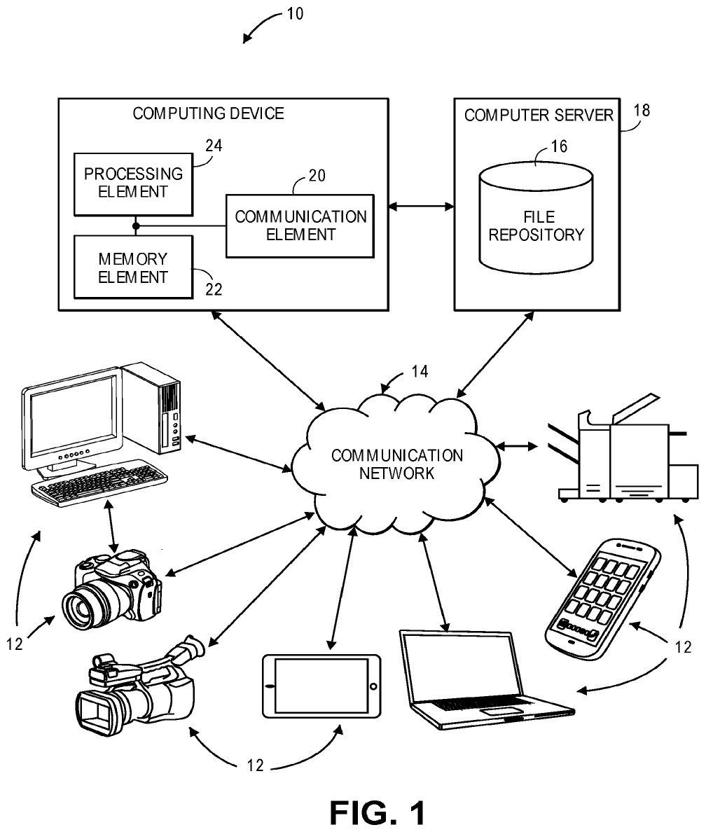

FIG. 1 depicts an exemplary environment in which embodiments of a computing device 10 may be utilized. The environment may include a plurality of electronic devices 12, a communication network 14, and a file repository 16 housed in a computer server 18. The computing device 10 may be configured or programmed to manage the analysis of image, video, audio, and document files captured by the electronic devices 12 and stored in the repository 16. The computing device 10 may be in the possession of, and operated by, a corporation such as an insurance provider or financial services provider.

The electronic devices 12 may be embodied by devices such as desktop computers, laptop computers, tablet computers, smartphones, PDAs, standalone cameras, video cameras, camcorders, document scanners and copiers, and the like. Many of the electronic devices 12, such as laptop computers, tablet computers, wearable electronics, smart watches, and smartphones or other mobile devices, may include a built-in camera capable of capturing images or taking pictures and storing the resulting image files. Typically, these electronic devices 12 also possess wireless communication abilities, which allow them to transmit the image files to the communication network 14. In addition, standalone traditional cameras, such as point and shoot, digital single lens reflex (DSLR), and so forth, may be utilized to capture images or take pictures and store the resulting image files on an internal memory card.

In some instances, the camera may be able to wirelessly transmit the image files to the communication network 14. Otherwise, the image files may be downloaded from the camera to another electronic device 12, such as a desktop computer, which may transmit the files to the communication network 14. The photographic image files may be stored in known image data formats, such as jpeg, gif, tiff, and the like.

Video footage may be captured by a video/picture camera, a camcorder, a smartphone, a drone, or the like and stored as video files. As with the image files, the video files may be transmitted to another electronic device 12, such as the desktop computer, or directly to the communication network 14. The video files may be stored in known video data formats, such as mp4, wmv, mov, avi, fly, and so forth.

The image and video capturing electronic devices 12 may be utilized by individuals, such as insurance agents, claims adjusters, and the like to take pictures or videos of an insured's property. The property may include houses, automobiles, motorcycles, boats, personal possessions such as watches, antiques, or jewelry, and so on. The property may be damaged, such as after an accident or a fire, or may be in good (undamaged) condition. The image and video files may be analyzed to determine the amount of reimbursement for a claim that was filed, determine an appropriate repair shop or a list of replacement parts for a damaged vehicle or a contractor to rebuild a damaged house, determine a value of a personal possession, and the like. The image and video files may further provide identification or be analyzed to determine an amount of a life insurance policy premium. In certain instances, a picture of a vehicle's odometer may be taken in order to verify automobile mileage.

Audio or sound may be captured by standalone microphones or electronic devices such as smartphones, personal data assistants (PDAs), or the like and may be stored in audio files. The audio of the audio files may include individuals providing statements, agents providing audio description, or sounds relevant to a claim. The audio may also provide a sample of an insured's, or a potential insured's, voice to verify identification or be analyzed to determine an amount of a life insurance policy premium. The audio files may be stored in known audio data formats, such as mp3, way, flac, wma, and so forth.

Images of documents may be captured by document scanners and copiers. The documents may include insurance policies, medical records, certificates, legal documents, and so forth. The scanned document files may be stored in various formats, such as pdf or one of the photographic image formats, and may be analyzed to extract the data contained therein.

The communication network 14 may generally allow communication between the electronic devices 12 and the computer server 18 housing the repository. The communication network 14 may include local area networks, metro area networks, wide area networks, cloud networks, the Internet, cellular networks, plain old telephone service (POTS) networks, and the like, or combinations thereof. The communication network 14 may be wired, wireless, or combinations thereof and may include components such as modems, gateways, switches, routers, hubs, access points, repeaters, towers, and the like. The electronic devices 12 may connect to the communication network 14 either through wires, such as electrical cables or fiber optic cables, or wirelessly, such as RF communication using wireless standards such as cellular 2G, 3G, or 4G, Institute of Electrical and Electronics Engineers (IEEE) 802.11 standards such as WiFi, IEEE 802.16 standards such as WiMAX, Bluetooth™, or combinations thereof.

The computer server 18 may generally retain the repository 16 and/or may respond to requests to retrieve data therefrom as well as to store data thereto. An exemplary computer server 18 may be embodied by database server, but may additionally include application servers, file servers, gaming servers, mail servers, print servers, web servers, or the like, or combinations thereof. Furthermore, the computer server 18 may include a cluster, a plurality of servers, virtual servers, or combinations thereof. The computer server 18 may also include processors, memory storage such as optical drives, hard disk drives, rack-mount drives, blade drives, and the like, and transceiver components that provide communication with the communication network 14. The computer server 18 may be configured to include or execute database applications, but may also include or execute software such as file storage applications, email or messaging applications, web server applications, or the like.

The repository 16 may generally include the image, video, audio, and document files received from the various electronic device 12 sources. The repository 16 may communicate with, or be integrated with, a next generation imaging system (NGIS). In addition, the repository 16 may include or be organized, arranged, or structured with a database architecture, such as a Hadoop database architecture. The repository 16 may be stored in the memory storage of the computer server 18.

The computing device 10 may be embodied by a server (similar to the computer server 18), a workstation computer, a desktop computer, or the like and may broadly comprise a communication element 20, a memory element 22, and a processing element 24.

The communication element 20 may generally allow the computing device 10 to communicate with the repository 16 housed in the computer server 18. The communication element 20 may include signal or data transmitting and receiving circuits, such as antennas, amplifiers, filters, mixers, oscillators, digital signal processors (DSPs), and the like. The communication element 20 may establish communication wirelessly by utilizing radio frequency (RF) signals and/or data that comply with communication standards such as cellular 2G, 3G, or 4G, IEEE 802.11 standards, IEEE 802.16 standards, or combinations thereof. In addition, the communication element 20 may utilize communication standards such as ANT, ANT+, Bluetooth™ low energy (BLE), the industrial, scientific, and medical (ISM) band at 2.4 gigahertz (GHz), or the like. Alternatively, or in addition, the communication element 20 may establish communication through connectors or couplers that receive metal conductor wires or cables which are compatible with networking technologies such as ethernet. In certain embodiments, the communication element 20 may also couple with optical fiber cables. The communication element 20 may be in communication with the processing element 24 and the memory element 22.

The memory element 22 may include electronic hardware data storage components such as read-only memory (ROM), programmable ROM, erasable programmable ROM, random-access memory (RAM) such as static RAM (SRAM) or dynamic RAM (DRAM), cache memory, hard disks, floppy disks, optical disks, flash memory, thumb drives, universal serial bus (USB) drives, or the like, or combinations thereof. In some embodiments, the memory element 22 may be embedded in, or packaged in the same package as, the processing element 24. The memory element 22 may include, or may constitute, a “computer-readable medium”. The memory element 22 may store the instructions, code, code segments, software, firmware, programs, applications, apps, services, daemons, or the like that are executed by the processing element 24.

The processing element 24 may include electronic hardware components, such as processors, microprocessors (single-core and multi-core), microcontrollers, digital signal processors (DSPs), field-programmable gate arrays (FPGAs), analog and/or digital application-specific integrated circuits (ASICs), or the like, or combinations thereof. The processing element 24 may generally execute, process, or run instructions, code, code segments, software, firmware, programs, applications, apps, processes, services, daemons, or the like. The processing element 24 may also include hardware components such as finite-state machines, sequential and combinational logic, and other electronic circuits that can perform the functions necessary for the operation of the current invention. The processing element 24 may be in communication with the communication element 20 and the memory element 22 through serial or parallel links that include address busses, data busses, control lines, and the like.

The processing element 24 may be configured or programmed, through hardware, firmware, software, or combinations thereof, to perform the following functions in managing the analysis of files stored in the repository 16. The processing element 24 may receive a request (through the communication network 14 and the communication element 20 of the computing device 10) from a group to add an analysis application to a registry of analysis applications. The request may be generated from a web page or a web portal served by or provided by the computing device 10. The web page may act as an interface to initiate the management of file analysis provided by the computing device 10. Alternatively, the request may be generated from an application, acting as the interface, executed on an electronic device similar in operation to the electronic device 12.

The group may be a group, a workgroup, a team, a department, an organization, a branch, a division, etc., within the insurance provider. The group requesting to add the analysis application want to make a determination of premium cost, reimbursement amount, etc., based upon the content of the files. The group may be different from the individuals who supply the files to the repository 16. The group may visit the web page, or run the interface application mentioned above, to make the request.

The analysis application may perform analysis of files in the repository 16 by applying algorithms, using computer or machine learning techniques such as artificial neural networks, and so forth to generate an analysis results file. For example, the analysis application may analyze one or more images or video of a damaged vehicle, and then determine an amount of financial reimbursement for the owner of the vehicle, which is likely the insured. The analysis application may also determine a list of repair parts for the vehicle, as well as a repair shop that may perform repairs. As another example, the analysis application may utilize image recognition techniques to determine a value of a vehicle's mileage from analyzing an image of the vehicle's odometer. As yet another example, the analysis application may apply optical character recognition (OCR) to determine the text and/or data from a scanned image of a document.

The registry of analysis applications may include a list, or database, of the analysis applications which are to be managed by the computing device 10. The list may also include the name of each group that provided the analysis application, the date the application was provided, as well as other information about the analysis application that is discussed below. The list may further include a pointer to the location of the analysis application. The registry may be stored in the memory element 22 of the computing device 10.

The processing element 24 may query the group to provide a specification of the types of files to be analyzed by the analysis application. For example, one group may be interested in auto insurance, and may register a first analysis application that analyzes images or video of undamaged vehicles. The group may register a second analysis application that analyzes images or video of damaged vehicles.

As a second example, another group may be interested in home insurance (and/or personal articles insurance), and may register at least two analysis applications including a first that analyzes images or video of undamaged houses (and/or personal articles) and a second that analyzes images or video of damaged houses (and/or personal articles). As a third example, various groups may be interested in document files, with certain groups interested in medical records and some groups interested in insurance documents, among others. The processing element 24 may receive the response provided by the group.

The processing element 24 may also query the group to provide an indication of whether to execute the analysis application in a near real-time fashion or whether to execute the analysis application at scheduled intervals. The analysis of some files may be time-sensitive, while other files may require analysis only periodically, such as once an hour or once per day. The processing element 24 may receive the response provided by the group.

The processing element 24 may further query the group to provide an indication of whether to analyze only the files that are newly added to the repository 16 or whether to also analyze previously-added files. The processing element 24 may receive the response provided by the group. If the group indicated that previously-added files should be processed, then the processing element 24 may determine which files that were previously added to the repository 16 that are of the type to be analyzed by the analysis application. Typically, the files in the repository 16 include metadata or tags that indicate what the content of the might be. For example, images of damaged vehicles may include tags such as “Auto damage front view” along with a creation date of the photo, a vehicle identification number (VIN) of the auto, or the like, videos of damaged houses may include tags that identify the address of the house and the type of damage, audio of an individual may include tags that identify the person and a descriptive title of the audio content, and document files may include tags that identify the content of the document. Accordingly, the processing element 24 may create a list of, or otherwise identify, all of the files whose metadata or tags match the type of file indicated by the group.

Then, the processing element 24 may execute the analysis application on the identified image files. The processing element 24 may create the analysis results file, which includes the analyzed data, for each of the files or group of related files that were analyzed. For example, the processing element 24 may execute the analysis application on a plurality of image or video files that include images or videos of the same vehicle that has been damaged. In such a case, the analysis results file may include an estimate of the amount of reimbursement to cover the damage to the vehicle, among other information. In other examples, the analysis results file may include the value of a vehicle's mileage derived from an image of the odometer, text and/or data determined from a scanned document image, and so forth. The processing element 24 may also create a log of which files were analyzed and send a message to the group indicating that the analysis has been completed.

The processing element 24 may receive an indication that image files of the specified type have been added to the repository. The indication may be generated by software running on the computer server 18 housing the repository 16, such as database management software. Alternatively, the processing element 24 may perform a periodic check of the repository 16 for newly-added files of the specified type. If the group indicated to execute the analysis application in near real-time fashion, then the processing element 24 may execute the analysis application on the newly-added files. The processing element 24 may also create a log of which files were analyzed and send a message to the group indicating that the analysis has been completed.

If regularly scheduled execution of the analysis application was indicated, then the processing element 24 may wait until the next scheduled time to execute the analysis application. At that point, the processing element 24 may execute the analysis application on the specified type of files that have been added since the last scheduled time. If the analysis application is executed for the first time, then the processing element 24 may execute the analysis application on all of the specified type of files in the repository 16. The processing element 24 may also create a log of which files were analyzed and send a message to the group indicating that the analysis has been completed.

Periodically, the group may create a new version or upgrade of the analysis application and may request that information about the new version be added to the registry of analysis applications. It is assumed that the operating parameters discussed above remain the same for the new version. However, the processing element 24 may query the group as to whether to reanalyze previously-analyzed files. Depending on the needs of the group or the features of the new version of the analysis application, such as improved accuracy of analysis results, it may be advantageous to reanalyze previously-analyzed files. Furthermore, the processing element 24 may query the group as to whether to overwrite the analysis results files from previously-analyzed files.

If the group indicated to reanalyze previously-analyzed files, then the processing element 24 may execute analysis application on previously-analyzed files. The processing element 24 may determine which files have previously been analyzed by examining the log files that are created after each the processing element 24 executes the analysis application. After the latest execution of the analysis application, the processing element 24 may update the log files. If the group indicated to overwrite the previously created analysis results files, then the processing element 24 may overwrite the analysis results files with new data.

### Exemplary Computer-Implemented Method

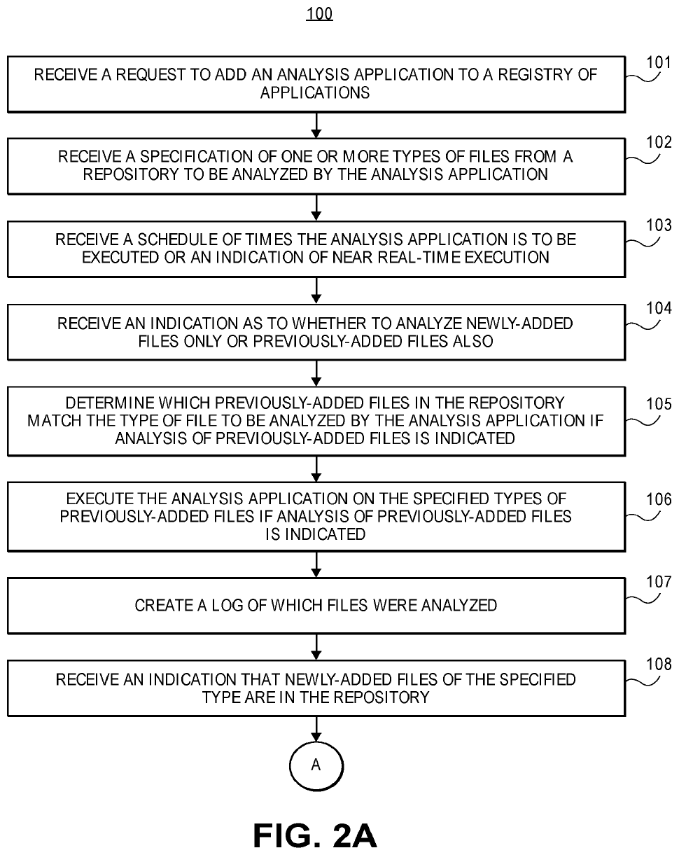

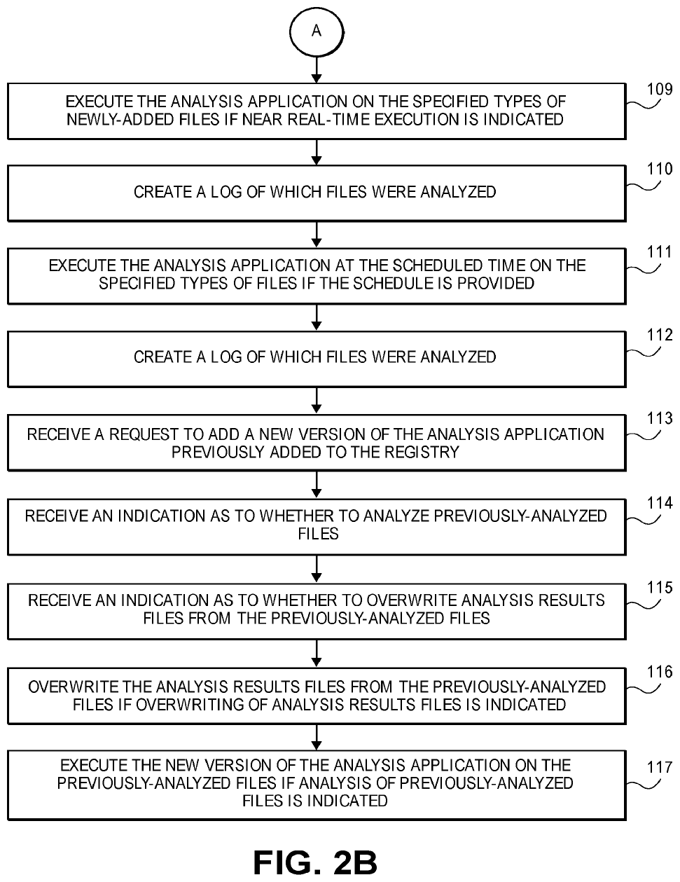

FIGS. 2A and 2B depict a listing of actions or steps of an exemplary computer-implemented method 100 for managing the analysis of image, video, audio, and document files stored in a repository 16. The actions may be performed in the order shown in FIGS. 2A and 2B, or they may be performed in a different order. Furthermore, some actions may be performed concurrently as opposed to sequentially. In addition, some actions may be optional. The actions of the computer-implemented method 100 may be performed by the computing device 10.

Referring to step 101, a request is received by the computing device 10 to add an analysis application to a registry of analysis applications. The request may be received from a group within an insurance provider. The group may be a group, a workgroup, a team, a department, an organization, a branch, a division, or the like. The request may be generated from a web page or a web portal served by or provided by the computing device 10. The web page may act as an interface to initiate the management of file analysis provided by the computing device 10. Alternatively, the request may be generated from an application, acting as the interface, executed on an electronic device similar in operation to the electronic device 12.

The analysis application may perform analysis of files in the repository 16 by applying algorithms, using computer or machine learning techniques such as artificial neural networks, and so forth to generate an analysis results file. For example, the analysis application may analyze one or more images or video of a damaged vehicle and determine an amount of financial reimbursement for the owner of the vehicle, which is likely the insured. For instance, the application may prepare a proposed insurance claim for an insured's review. Damage of the vehicle may be estimated from analysis of the images or video of the damaged vehicle.

The analysis application may also determine a list of repair parts for the vehicle, as well as a repair shop that could performs repairs. For instance, repair parts may be determined from processor analysis of the images or videos. Also, repair shops with the requisite parts may be determined, as well as repair shops that are qualified to perform the repairs.

As another example, the analysis application may utilize image recognition techniques to determine a value of a vehicle's mileage from analyzing an image of the vehicle's odometer. For instance, period time-stamped images of a vehicle's odometer may be used to generate usage-based insurance, and/or to verify an amount of miles that a vehicle is driven by an operator.

As yet another example, the analysis application may apply optical character recognition (OCR) to determine the text and/or data from a scanned image of a document. For instance, user manuals, appraisals, repair estimates, financial documents, deeds or titles, driver licenses, etc. may all have images gathered for various types of insurance and/or financial services-related purposes.

The registry of analysis applications may include a list of the analysis applications which are to be managed by the computing device 10. The list may also include the name of each group (such as auto insurance, homeowners insurance, life insurance, home loan, auto loan, etc.) that provided the analysis application, the date the application was provided, as well as other information about the analysis application that is discussed below. The list may further include a pointer to the location of the analysis application. The registry may be stored in the memory element 22 of the computing device 10.

Referring to step 102, a specification of one or more types of files from the repository 16 to be analyzed by the analysis application is received. The indication may be received from the group in response to a query to identify types of files to be analyzed. For example, one group may be interested in auto insurance and may register a first analysis application that analyzes images or video of undamaged vehicles. The group may register a second analysis application that analyzes images or video of damaged vehicles. In one embodiment, an application, such as a machine learning program, may access the files of the undamaged and damaged images or video to train itself to estimate vehicle damage and/or estimate type and cost or repairs needed after a vehicle collision. After a vehicle collision, an image or video of a damaged vehicle may be received from an insured's mobile device and analyzed via the machine learning program to prepare a proposed insurance claim for the insured's review and approval.

As a second example, another group may be interested in home insurance and may register at least two analysis applications including a first that analyzes images or video of undamaged houses (and personal belongings therein) and a second that analyzes images or video of damaged houses (and personal belongings therein). As a third example, various groups may be interested in document image files, with certain groups interested in medical records and some groups interested in insurance documents, among others.

Referring to step 103, a schedule of times the analysis application is to be executed is received. The schedule is received from the group in response to a query regarding the times or circumstances under which the analysis application is to be executed. If the group wishes for near real-time execution of the analysis application, then they may indicate as such. The analysis of some files may be time-sensitive, while other files may require analysis only periodically, such as once an hour or once per day.

Referring to step 104, an indication as to whether to analyze newly-added files only, previously-added files, or both is received. The indication may be received from the group in response to a query regarding the creation date of files to be analyzed.

Referring to step 105, the previously-added files in the repository match that the type of file to be analyzed are determined. Typically, the files in the repository 16 include metadata or tags that indicate what the content of the image might be. For example, images of damaged vehicles may include tags such as “Auto damage front view” along with a creation date of the photo, a vehicle identification number (VIN) of the auto, or the like, videos of damaged houses may include tags that identify the address of the house and the type of damage, audio of an individual may include tags that identify the person and a descriptive title of the audio content, and document files may include tags that identify the content of the document. Accordingly, the computing device 10 may create a list of, or otherwise identify, all of the files whose metadata or tags match the type of file indicated by the group.

Referring to steps 106 and 107, the analysis application may be executed on the specified types of previously-added files. The computing device 10 may create an analysis results file, which includes the analyzed data, for each of the files or group of related files that were analyzed. For example, the computing device 10 may execute the analysis application on a plurality of files that include images of the same vehicle that has been damaged. In such a case, the analysis results file may include an estimate of the amount of reimbursement under an auto insurance policy to cover the damage to the vehicle, among other information. In other examples, the analysis results file may include the value of a vehicle's mileage derived from an image of the odometer, text and/or data determined from a scanned document image, and so forth. The computing device 10 may also create a log of which files were analyzed and send a message to the group indicating that the analysis has been completed.

Referring to steps 108, 109, and 110, an indication that newly-added files of the specified type are in the repository is received. The indication may be generated by software running on the computer server 18 housing the repository 16, such as database management software. Alternatively, the computing device 10 may perform a periodic check of the repository 16 for newly-added files of the specified type. If the group indicated to execute the analysis application in near real-time fashion, then the computing device 10 may execute the analysis application on the newly-added files. The computing device 10 may also create a log of which files were analyzed and send a message to the group indicating that the analysis has been completed.

Referring to steps 111 and 112, the analysis application is executed at the next scheduled time, if a schedule of times was provided by the group. If the analysis application has already been executed, then the computing device 10 may execute the analysis application on the specified type of files that have been added since the last scheduled time. If the analysis application is executed for the first time, then the computing device 10 may execute the analysis application on all of the specified type of files in the repository 16. The computing device 10 may also create a log of which files were analyzed and send a message to the group indicating that the analysis has been completed.

Referring to steps 113-117, a request to add a new version of the analysis application is received. Information about the new version may be added to the registry of analysis applications. It is assumed that the operating parameters discussed above remain the same for the new version. However, the computing device 10 may query the group as to whether to reanalyze previously-analyzed files. Depending on the needs of the group or the features of the new version of the analysis application, such as improved accuracy of analysis results, it may be advantageous to reanalyze previously-analyzed files. Furthermore, the computing device 10 may query the group as to whether to overwrite the analysis results files from previously-analyzed files.

If the group indicated to reanalyze previously-analyzed files, then the computing device 10 may execute analysis application on previously-analyzed files. The computing device 10 may determine which files have previously been analyzed by examining the log files that are created after each the computing device 10 executes the analysis application. After the latest execution of the analysis application, the computing device 10 may update the log files. If the group indicated to overwrite the previously created analysis results files, then the computing device 10 may overwrite the analysis results files with new data.

### Exemplary Computer-Implemented Method for Managing the Analysis of Image, Video, Audio, and Document Files Stored in a Repository

In a first aspect, a computer-implemented method for managing the analysis of image, video, audio, and document files stored in a repository may be provided. The method may include: (1) receiving a request to add an analysis application to a registry of applications; (2) receiving a specification of one or more types of files from the repository to be analyzed by the analysis application; (3) receiving a schedule of times at which the analysis application is to be executed or an indication of near real-time execution; (4) executing the analysis application on the specified types of files at the scheduled time if the schedule of times is received; (5) receiving a first indication that the specified types of files have been added to the repository; and/or (6) executing the analysis application on the specified types of files if near real-time execution is indicated. The method may include additional, fewer, or alternative actions, including those discussed elsewhere herein.

For instance, the method may include: receiving a second indication whether to analyze newly-added files only or whether to additionally analyze previously-added files; executing the analysis application on the previously-added files if analysis of previously-added files is indicated; receiving a request to add a new version of the analysis application to the registry of applications; receiving a third indication whether to analyze previously-analyzed files; executing the new version of the analysis application on previously-analyzed files if analysis of previously-analyzed files is indicated; receiving a fourth indication whether to overwrite analysis results files that were created during previous execution of the analysis application; overwriting the analysis results files from the previous executions of the analysis application if overwriting of analysis results files is indicated; and/or creating a log of files that were analyzed each time the analysis application is executed. In addition, executing the analysis application on the specified types of files at the scheduled time if the schedule of times is received includes executing the analysis application on the specified types of files added to the repository since the last scheduled time if the analysis application has been executed previously, and executing the analysis application on all of the specified types of files in the repository if the analysis application is executed for the first time.

### Exemplary Computer-Readable Medium for Managing the Analysis of Image, Video, Audio, and Document Files Stored in a Repository

In another aspect, a computer-readable medium for managing the analysis of image, video, audio, and document files stored in a repository may be provided. The computer-readable medium may include an executable program stored thereon, wherein the program instructs a processing element of a computing device to perform the following: (1) receiving a request to add an analysis application to a registry of applications; (2) receiving a specification of one or more types of files from the repository to be analyzed by the analysis application; (3) receiving a schedule of times at which the analysis application is to be executed or an indication of near real-time execution; (4) executing the analysis application on the specified types of files at the scheduled time if the schedule of times is received; (5) receiving a first indication that the specified types of files have been added to the repository; and/or (6) executing the analysis application on the specified types of files if near real-time execution is indicated. The program stored on the computer-readable medium may instruct the processing element to perform additional, fewer, or alternative actions, including those discussed elsewhere herein.

For instance, the program may instruct the processing element to: receive a second indication whether to analyze newly-added files only or whether to additionally analyze previously-added files; execute the analysis application on the previously-added files if analysis of previously-added files is indicated; receive a request to add a new version of the analysis application to the registry of applications; receive a third indication whether to analyze previously-analyzed files; execute the new version of the analysis application on previously-analyzed files if analysis of previously-analyzed files is indicated; receive a fourth indication whether to overwrite analysis results files that were created during previous execution of the analysis application; overwrite the analysis results files from the previous executions of the analysis application if overwriting of analysis results files is indicated; and/or create a log of files that were analyzed each time the analysis application is executed. In addition, executing the analysis application on the specified types of files at the scheduled time if the schedule of times is received includes executing the analysis application on the specified types of files added to the repository since the last scheduled time if the analysis application has been executed previously, and executing the analysis application on all of the specified types of files in the repository if the analysis application is executed for the first time.

### Exemplary Computing Device for Managing the Analysis of Image, Video, Audio, and Document Files Stored in a Repository

In yet another aspect, a computing device for managing the analysis of image, video, audio, and document files stored in a repository may be provided. The computing device may include a communication element, a memory element, and a processing element. The communication element may communicate with the repository. The memory element may be electronically coupled to the communication element and may store executable instructions. The processing element may be electronically coupled to the communication element and the memory element. The processing element may be configured to (1) receive a request to add an analysis application to a registry of applications; (2) receive a specification of one or more types of files from the repository to be analyzed by the analysis application; (3) receive a schedule of times at which the analysis application is to be executed or an indication of near real-time execution; (4) execute the analysis application on the specified types of files at the scheduled time if the schedule of times is received; receive a first indication that the specified types of files have been added to the repository; and/or (5) execute the analysis application on the specified types of files if near real-time execution is indicated. The computing device may include additional, fewer, or alternate components and/or functionality, including that discussed elsewhere herein.

For instance, the processing element may be further configured to: receive a second indication whether to analyze newly-added files only or whether to additionally analyze previously-added files; execute the analysis application on the previously-added files if analysis of previously-added files is indicated; receive a request to add a new version of the analysis application to the registry of applications; receive a third indication whether to analyze previously-analyzed files; execute the new version of the analysis application on previously-analyzed files if analysis of previously-analyzed files is indicated; receive a fourth indication whether to overwrite analysis results files that were created during previous execution of the analysis application; overwrite the analysis results files from the previous executions of the analysis application if overwriting of analysis results files is indicated; and/or create a log of files that were analyzed each time the analysis application is executed. In addition, executing the analysis application on the specified types of files at the scheduled time if the schedule of times is received includes executing the analysis application on the specified types of files added to the repository since the last scheduled time if the analysis application has been executed previously, and executing the analysis application on all of the specified types of files in the repository if the analysis application is executed for the first time.

### Exemplary System

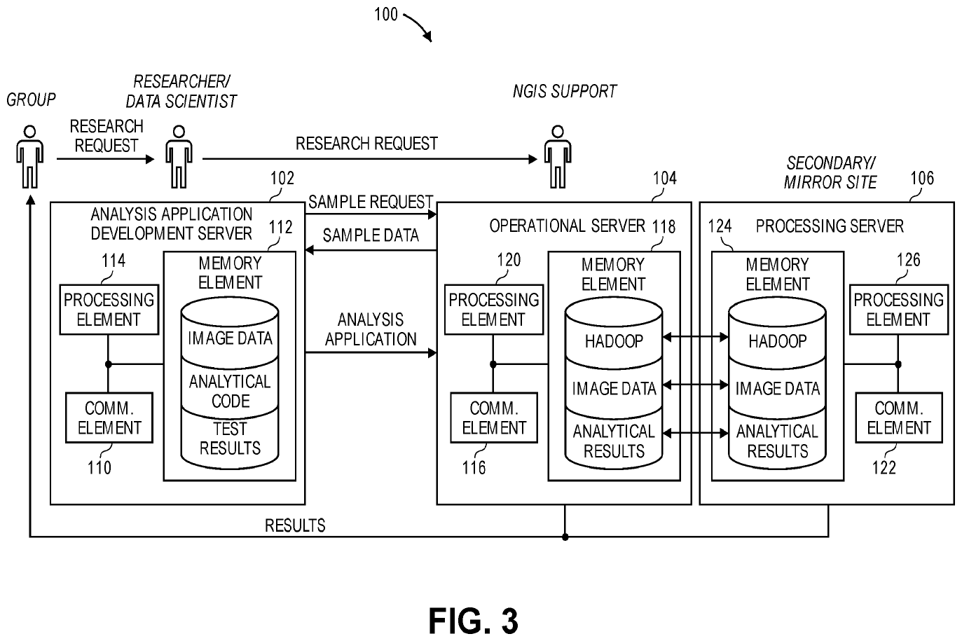

FIG. 3 depicts an exemplary environment in which embodiments of a system 100 for managing the analysis of image, video, audio, and document files stored in a repository may operate. The system 100 may broadly comprise an analysis application development server 102, an operational server 104, and a processing server 106. The servers 102, 104, 106 may each include a communication element 110, 116, 122, a memory element 112, 118, 124, and a processing element 114, 120, 126 (numbered respectively). The system 100 may be utilized in situations where a group (a workgroup, a team, a department, an organization, a branch, a division, etc.) within a corporation, such as an insurance or financial provider, may wish to have certain files analyzed, but may not necessarily have the means to create an analysis application themselves. The system 100 may also be utilized in situations where the operational server 104 is required to perform processing other than the analysis of files.

The communication elements 110, 116, 122 may each be similar in structure and function to the communication element 20 described above and may allow each server 102, 104, 106 to communicate with the other servers as well as external systems and devices. The memory elements 112, 118, 124 may each be similar in structure and function to the memory element 22 described above and may include optical drives, hard disk drives, rack-mount drives, blade drives, and the like. The processing elements 114, 120, 126 may each be similar in structure and function to the processing element 24 described above.

The analysis application development server 102 generally allows researchers, data scientists, programmers, developers, coders, and the like to develop one or more analysis applications without disturbing the operation, function, or action of the operational server 104. The analysis application development server 102 may be similar to the computer server 18 and may be embodied by database server, but may additionally include application servers, file servers, gaming servers, mail servers, print servers, web servers, or the like, or combinations thereof. Furthermore, the analysis application development server 102 may include a cluster, a plurality of servers, virtual servers, or combinations thereof. The memory element 112 may store sample files, analysis applications that are being developed, and analysis results files for the development process. The processing element 114 may be configured or programmed to execute analysis applications which are in development.

The operational server 104 generally provides regular operational file service for files to all employees of the insurance provider. The operational server 104 and the processing server 106 may be maintained and supported by NGIS support staff. Like the analysis application development server 102, the operational server 104 may include various types of servers as well as multiple servers and virtual servers. At least a portion of the memory element 118 may include or be organized, arranged, or structured with a database architecture, such as a Hadoop database architecture. The memory element 118 may include a repository similar to the repository 16 which stores files, such as photographs and scanned documents, that are received from devices such as the electronic devices 12. The memory element 118 may also store the analysis applications along with a registry of the analysis applications, although the analysis applications are not necessarily executed by the operational server 104. Furthermore, the memory element 118 may store, at least temporarily, analysis results files that include the results of one or more analysis applications being executed on one or more files. In some instances, the operational server 104 may transmit the analysis results files to a location specified by the group. The processing element 120 may be programmed or configured to perform file serving functions. That is, the processing element 120 may manage the storage and retrieval of the files as well as the analysis results files.

The processing server 106 generally provides execution of analysis applications. The processing server 106 receive requests to register and execute analysis applications in addition to, or instead of, the operational server 104. The processing server 106 may also serve as a tier 2, mirror, secondary, backup, or disaster recovery server to the operational server 104—providing duplicate operation thereof—and may include the same types of components as the operational server 104. Thus, the memory element 124 may have the same database structure and may store the same files, analysis applications, registry of analysis applications, and analysis results files as the operational server 104. Accordingly, there may be high volume communication at regular intervals between the operational server 104 and the processing server 106 to synchronize the data on the two servers. The processing element 126 may be programmed or configured to execute the analysis applications and generate the analysis results files in the same manner as the computing device 10 discussed above. Therefore, the processing element 126 may receive requests to add analysis applications, specifications of file types to be analyzed, schedules of times for analysis, and so forth. More specifically, the processing element 126 may receive a request to add an analysis application to a registry of applications; receive a specification of one or more types of files from the repository to be analyzed by the analysis application; receive a schedule of times at which the analysis application is to be executed or an indication of near real-time execution; execute the analysis application on the specified types of files added to the repository since the last scheduled time if the schedule of times is received and if the analysis application has been executed previously; execute the analysis application on all of the specified types of files in the repository if the schedule of times is received and if the analysis application is executed for the first time; receive a first indication that the specified types of files have been added to the repository; execute the analysis application on the specified types of files if near real-time execution is indicated; receive a second indication whether to analyze newly-added files only or whether to additionally analyze previously-added files; execute the analysis application on the previously-added files if analysis of previously-added files is indicated; receive a request to add a new version of the analysis application to the registry of applications; receive a third indication whether to analyze previously-analyzed files; execute the new version of the analysis application on previously-analyzed files if analysis of previously-analyzed files is indicated; receive a fourth indication whether to overwrite analysis results files that were created during previous execution of the analysis application; and overwrite the analysis results files from the previous executions of the analysis application if overwriting of analysis results files is indicated. In this regard, execution of the analysis applications does not interfere with the file serving activities of the operational server 104.

With reference to FIG. 3, the system 100 may operate as follows. The memory element 112 of the operational server 104 may receive files on a regular basis which are to be analyzed for various groups within the insurance provider. A group has a need to analyze files to estimate repair or replacement costs of damaged vehicles, for example. However, the group may not have the personnel or resources to create the software necessary to perform the image or video analysis. Within the insurance provider organization, there may exist researchers, data scientists, programmers, developers, coders, and the like who can write and test an analysis application that would perform the proper analysis. Thus, the group may send a request to the researchers to create software that will analyze damaged vehicle photos. The request may identify the types of photos to analyze, the nature of the analysis to perform, whether to analyze previously-added files or only newly-added files, how often to perform the analysis, and so forth. Once the researchers develop a plan to write and test the analysis application, they may send a request to the NGIS support staff to release sample files of the proper type to use as test cases so as not to disturb the normal operation or functioning of the operational server 104. The operational server 104 may then transmit the sample files to the analysis application development server 102.

The researchers may then write and test the analysis application using the analysis application development server 102. It is possible that periodically a request for new sample files may be transmitted from the analysis application development server 102 to the operational server 104, which may reply with new files. Once the analysis application is complete, the analysis application development server 102 may transmit, as prompted by the researchers, a request to the operational server 104 to add or register the newly-created analysis application. The request may include all of the information necessary to complete the registration process and may be handled in the same manner as discussed above for the computing device 10, with the operational server 104 and/or the processing server 106 receiving all of the specifications for executing the analysis application.

Under normal operating conditions, the operational server 104 may provide routine file service to all of the employees of the insurance provider. For example, insurance agents, customer representatives, accounting personnel, and others may add, retrieve, or access files on the operational server 104. As files are received for storage on the operational server 104, they are also mirrored and stored on the processing server 106. At the same time, the processing server 106 may execute the analysis applications which analyze the files. The analysis results files may be stored on both the processing server 106 and the operational server 104. Additionally, or alternatively, the analysis results files may be transmitted to other locations as indicated by the groups requesting analysis of the files.

### Exemplary System for Managing the Analysis of Image, Video, Audio, and Document Files Stored in a Repository

In yet another aspect, a system for managing the analysis of image, video, audio, and document files stored in a repository may be provided. The system may include an analysis application development server, an operational server, and a processing server. The analysis application development server may be utilized to develop analysis applications which analyze the files and may include a memory element and a processing element. The memory element may be configured to store a plurality of files, one or more analysis applications in development, and a plurality of analysis results files including results from execution of the one or more analysis applications in development. The processing element may be configured to execute analysis applications in development. The operational server may allow users to store and retrieve files which will be analyzed and may include a memory element and a processing element. The memory element may be configured to include a database architecture and to store a plurality of files, a plurality of analysis applications, and a plurality of analysis results files including results from execution of the one or more analysis applications. The processing element may be configured to manage storage and retrieval of files in the memory element. The processing server may execute analysis applications and may include a memory element and a processing element. The memory element may be a duplicate of the memory element of the operational server. The processing element may be configured to execute the analysis applications and generate analysis results files. The system may include additional, fewer, or alternate components and/or functionality, including that discussed elsewhere herein.

For instance, the processing element of the processing server may be further configured to: receive a request to add an analysis application to a registry of applications; receive a specification of one or more types of files from the repository to be analyzed by the analysis application; receive a schedule of times at which the analysis application is to be executed or an indication of near real-time execution; execute the analysis application on the specified types of files added to the repository since the last scheduled time if the schedule of times is received and if the analysis application has been executed previously; execute the analysis application on all of the specified types of files in the repository if the schedule of times is received and if the analysis application is executed for the first time; receive a first indication that the specified types of files have been added to the repository; execute the analysis application on the specified types of files if near real-time execution is indicated; receive a second indication whether to analyze newly-added files only or whether to additionally analyze previously-added files; execute the analysis application on the previously-added files if analysis of previously-added files is indicated; receive a request to add a new version of the analysis application to the registry of applications; receive a third indication whether to analyze previously-analyzed files; execute the new version of the analysis application on previously-analyzed files if analysis of previously-analyzed files is indicated; receive a fourth indication whether to overwrite analysis results files that were created during previous execution of the analysis application; and overwrite the analysis results files from the previous executions of the analysis application if overwriting of analysis results files is indicated.

### Additional Considerations

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current technology can include a variety of combinations and/or integrations of the embodiments described herein.

Although the present application sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processing element, may be implemented as special purpose or as general purpose. For example, the processing element may comprise dedicated circuitry or logic that is permanently configured, such as an application-specific integrated circuit (ASIC), or indefinitely configured, such as an FPGA, to perform certain operations. The processing element may also comprise programmable logic or circuitry (e.g., as encompassed within a general-purpose processor or other programmable processor) that is temporarily configured by software to perform certain operations. It will be appreciated that the decision to implement the processing element as special purpose, in dedicated and permanently configured circuitry, or as general purpose (e.g., configured by software) may be driven by cost and time considerations.

Accordingly, the term “processing element” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processing element is temporarily configured (e.g., programmed), each of the processing elements need not be configured or instantiated at any one instance in time. For example, where the processing element comprises a general-purpose processor configured using software, the general-purpose processor may be configured as respective different processing elements at different times. Software may accordingly configure the processing element to constitute a particular hardware configuration at one instance of time and to constitute a different hardware configuration at a different instance of time.

Computer hardware components, such as communication elements, memory elements, processing elements, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processing elements that are temporarily configured (e.g., by software) or permanently configured to perform the relevant operations. Whether temporarily or permanently configured, such processing elements may constitute processing element-implemented modules that operate to perform one or more operations or functions. The modules referred to herein may, in some example embodiments, comprise processing element-implemented modules.

Similarly, the methods or routines described herein may be at least partially processing element-implemented. For example, at least some of the operations of a method may be performed by one or more processing elements or processing element-implemented hardware modules. The performance of certain of the operations may be distributed among the one or more processing elements, not only residing within a single machine, but deployed across a number of machines. In some example embodiments, the processing elements may be located in a single location (e.g., within a home environment, an office environment or as a server farm), while in other embodiments the processing elements may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processing element and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The patent claims at the end of this patent application are not intended to be construed under 35 U. S.C. § 112(f) unless traditional means-plus-function language is expressly recited, such as “means for” or “step for” language being explicitly recited in the claim(s).

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A computer-implemented method for managing the analysis of image and/or video files stored in a repository, the computer-implemented method comprising, via one or more processors:
receiving a request to add a first analysis application to a registry of applications;
receiving a specification of one or more first types of files from the repository to be analyzed by the first analysis application;
receiving a schedule of times at which the first analysis application is to be executed or an indication of near real-time execution;
executing the first analysis application on the specified first types of files at the scheduled time if the schedule of times is received;
receiving a first indication that the specified first types of files have been added to the repository;
executing the first analysis application on the specified first types of files if near real-time execution is indicated;
receiving a request to add a second analysis application to the registry of applications;
receiving a specification of one or more second types of files from the repository to be analyzed by the second analysis application; and
executing the second analysis application on the specified second types of files at one of a scheduled time or near real-time.

2. The computer-implemented method of claim 1, further comprising receiving a second indication whether to analyze newly-added files only or whether to additionally analyze previously-added files, and executing the first analysis application on the previously-added files if analysis of previously-added files is indicated.

3. The computer-implemented method of claim 1, further comprising receiving a request to add a new version of the first analysis application to the registry of applications, receiving a third indication whether to analyze previously-analyzed files, and executing the new version of the first analysis application on previously-analyzed files if analysis of previously-analyzed files is indicated.

4. The computer-implemented method of claim 3, further comprising receiving a fourth indication whether to overwrite analysis results files that were created during previous execution of the first analysis application, and overwriting the analysis results files from the previous executions of the first analysis application if overwriting of analysis results files is indicated.

5. The computer-implemented method of claim 1, further comprising creating a log of files that were analyzed each time the first analysis application is executed.

6. The computer-implemented method of claim 1, wherein executing the first analysis application on the specified first types of files at the scheduled time if the schedule of times is received includes executing the first analysis application on the specified first types of files added to the repository since the last scheduled time if the first analysis application has been executed previously, and executing the first analysis application on all of the specified first types of files in the repository if the first analysis application is executed for the first time.

7. A non-transitory computer-readable medium with an executable program stored thereon for managing the analysis of image and/or video files stored in a repository, wherein the program instructs a processing element of a computing device to perform the following steps:
receiving a request to add a first analysis application to a registry of applications;
receiving a specification of one or more first types of files from the repository to be analyzed by the first analysis application;
receiving a schedule of times at which the first analysis application is to be executed or an indication of near real-time execution;
executing the first analysis application on the specified first types of files at the scheduled time if the schedule of times is received;
receiving a first indication that the specified first types of files have been added to the repository;
executing the first analysis application on the specified first types of files if near real-time execution is indicated;
receiving a request to add a second analysis application to the registry of applications;
receiving a specification of one or more second types of files from the repository to be analyzed by the second analysis application; and
executing the second analysis application on the specified second types of files at one of a scheduled time or near real-time.

8. The non-transitory computer-readable medium of claim 7, wherein the program further instructs the processing element to receive a second indication whether to analyze newly-added files only or whether to additionally analyze previously-added files, and execute the first analysis application on the previously-added files if analysis of previously-added files is indicated.

9. The non-transitory computer-readable medium of claim 7, wherein the program further instructs the processing element to receive a request to add a new version of the first analysis application to the registry of applications, receive a third indication whether to analyze previously-analyzed files, and execute the new version of the first analysis application on previously-analyzed files if analysis of previously-analyzed files is indicated.

10. The non-transitory computer-readable medium of claim 7, wherein the program further instructs the processing element to receive a fourth indication whether to overwrite analysis results files that were created during previous execution of the first analysis application, and overwrite the analysis results files from the previous executions of the first analysis application if overwriting of analysis results files is indicated.

11. The non-transitory computer-readable medium of claim 7, wherein the program further instructs the processing element to create a log of files that were analyzed each time the first analysis application is executed.

12. The non-transitory computer-readable medium of claim 7, wherein executing the first analysis application on the specified first types of files at the scheduled time if the schedule of times is received includes executing the first analysis application on the specified first types of files added to the repository since the last scheduled time if the first analysis application has been executed previously, and executing the first analysis application on all of the specified first types of files in the repository if the first analysis application is executed for the first time.

13. A computing device for managing the analysis of image and/or video files stored in a repository, the device comprising:
a communication element configured to communicate with the repository;
a memory element electronically coupled to the communication element, the memory element configured to store executable instructions; and
a processing element electronically coupled to the communication element and the memory element, the processing element configured to receive a request to add a first analysis application to a registry of applications;
receive a specification of one or more first types of files from the repository to be analyzed by the first analysis application;
receive a schedule of times at which the first analysis application is to be executed or an indication of near real-time execution;
execute the first analysis application on the specified first types of files at the scheduled time if the schedule of times is received;
receive a first indication that the specified first types of files have been added to the repository;
execute the first analysis application on the specified first types of files if near real-time execution is indicated;
receive a request to add a second analysis application to the registry of applications;
receive a specification of one or more second types of files from the repository to be analyzed by the second analysis application; and
execute the second analysis application on the specified second types of files at one of a scheduled time or near real-time.

14. The computing device of claim 13, wherein the processing element is further configured to receive a second indication whether to analyze newly-added files only or whether to additionally analyze previously-added files, and execute the first analysis application on the previously-added files if analysis of previously-added files is indicated.

15. The computing device of claim 13, wherein the processing element is further configured to receive a request to add a new version of the first analysis application to the registry of applications, receive a third indication whether to analyze previously-analyzed files, and execute the new version of the first analysis application on previously-analyzed files if analysis of previously-analyzed files is indicated.

16. The computing device of claim 13, wherein the processing element is further configured to receive a fourth indication whether to overwrite analysis results files that were created during previous execution of the first analysis application, and overwrite the analysis results files from the previous executions of the first analysis application if overwriting of analysis results files is indicated.

17. The computing device of claim 13, wherein the processing element is further configured to create a log of files that were analyzed each time the first analysis application is executed.

18. The computing device of claim 13, wherein executing the first analysis application on the specified first types of files at the scheduled time if the schedule of times is received includes executing the first analysis application on the specified first types of files added to the repository since the last scheduled time if the first analysis application has been executed previously, and executing the first analysis application on all of the specified first types of files in the repository if the first analysis application is executed for the first time.

19. The computer-implemented method of claim 1, wherein the specified first types of files are the same as the specified second types of files.

20. The computer-implemented method of claim 19, wherein the first analysis application is different from the second analysis application.
